(19) United States
(12) Patent Application Publication
(10) Pub. No.: US 2014/0324720 A1
(43) Pub. Date: Oct. 30, 2014

(54) METHOD, SYSTEM, INTELLIGENT TERMINAL AND STORAGE MEDIUM FOR INFORMATION RECOMMENDATION

(71) Applicant: TENCENT TECHNOLOGY (SHENZHEN) COMPANY LIMITED, Shenzhen (CN)

(72) Inventors: Liwei Ye, Shenzhen (CN); Heng Yang, Shenzhen (CN); Bin Li, Shenzhen (CN)

(21) Appl. No.: 14/324,792

(22) Filed: Jul. 7, 2014

Related U.S. Application Data
(63) Continuation of application No. PCT/CN2013/090995, filed on Dec. 31, 2013.

(30) Foreign Application Priority Data
Mar. 14, 2013 (CN) 201310081752.0

(51) Int. Cl. G06Q 50/00; G06Q 10/10; G06Q 10/00

(52) U.S. Cl. CPC G06Q 50/01; G06Q 10/00; G06Q 10/109
USPC 705/319

(57) ABSTRACT

The present disclosure provides a method, system, intelligent terminal and storage medium for information recommendation, wherein, the method includes: uploading contact information to a server, by an intelligent terminal; storing the contact information uploaded by the intelligent terminal and acquiring a social account number of a user of the intelligent terminal, by the server; acquiring friend information of the social account number according to the social account number, and matching the acquired friend information with the contact information, then returning the friend information which is successfully matched to the intelligent terminal, by the server; receiving and storing the friend information which is successfully matched, and recommending the friend information which is successfully matched to the user of the intelligent terminal, by the intelligent terminal; and the friend information which is successfully matched including information that has not been set in the contact information of the intelligent terminal.

This application claims priority to and is a continuation application of PCT/CN2013/090995, filed on Dec. 31, 2013 and entitled “METHOD, SYSTEM, INTELLIGENT TERMINAL AND STOREAGE MEDIUM FOR INFORMATION RECOMMENDATION”, which claims priority to Chinese patent application number 201310081752.0, filed on Mar. 14, 2013, by “TENCENT TECHNOLOGY (SHENZHEN) COMPANY LIMITED”, the disclosures of which are incorporated herein by reference in their entirety.

### TECHNICAL FIELD

The present disclosure is related to the field of information processing technologies, in particular to a method, system, intelligent terminal and storage medium for information recommendation.

### Technical Background

Address lists in existing intelligent terminals generally include functions for setting information of contacts. However, when a user sets contact information locally, only some simple information such as names and telephone numbers of contacts will generally be set. For some kinds of information such images and birthdays of contacts, the possibility for being actively set by the user is relatively low, since the setting is relatively troublesome for example in that it is required to ask contacts for their birthdays and ask contacts to send their images, thus resulting the contact information incomplete.

### SUMMARY OF THE INVENTION

On objective of the present disclosure is to provide a method, system, intelligent terminal and storage medium for information recommendation, to solve one or more problems set forth above and other problems. In addition, this section provides a general summary of the disclosure, and is not a comprehensive disclosure of its full scope or all of its features.

In a first aspect, an embodiment of the present disclosure provides a method for information recommendation, comprising the step of:

uploading contact information to a server, by an intelligent terminal;

storing the contact information uploaded by the intelligent terminal and acquiring a social account number of a user of the intelligent terminal, by the server;

acquiring friend information of the social account number according to the social account number, and matching the acquired friend information with the contact information, then returning the friend information which is successfully matched to the intelligent terminal, by the server;

receiving and storing the friend information which is successfully matched, and recommending the friend information which is successfully matched to the user of the intelligent terminal, by the intelligent terminal;

wherein the friend information which is successfully matched comprises information that has not been set in the contact information of the intelligent terminal.

In a second aspect, an embodiment of the present disclosure provides a system for information recommendation, characterized by comprising:

a server and an intelligent terminal:

the intelligent terminal is configured to upload contact information to a server and receive and store the friend information which is successfully matched returned by the server, and recommend the friend information which is successfully matched to the user of the intelligent terminal;

the server is configured to store the contact information uploaded by the intelligent terminal and acquire a social account number of a user of the intelligent terminal, then acquire friend information of the social account number according to the social account number, and match the acquired friend information with the contact information, then return the friend information which is successfully matched to the intelligent terminal;

wherein the friend information which is successfully matched includes information that has not been set in the contact information of the intelligent terminal.

In a third aspect, an embodiment of the present disclosure provides an intelligent terminal, characterized by comprising:

an information uploading unit configured to upload contact information to a server to enable the server to store the contact information and acquire a social account number of a user of the intelligent terminal once receiving the contact information, then acquire friend information of the social account number according to the social account number, and match the acquired friend information with the contact information, then return the friend information Which is successfully matched to the intelligent terminal;

an information storage unit configured to receive and store the friend information Which is successfully matched returned by the server;

an information recommendation unit configured to recommend the friend information Which is successfully matched to the user of the intelligent terminal;

wherein the friend information which is successfully matched including information that has not been set in the contact information of the intelligent terminal.

In a fourth aspect, an embodiment of the invention provides a storage medium containing computer executable instructions for executing a method for information recommendation when executed by a computer processor, characterized in that the method comprises:

uploading contact information to a server, by an intelligent terminal;

storing the contact information uploaded by the intelligent terminal and acquiring a social account number of a user of the intelligent terminal, by the server;

acquiring friend information of the social account number according to the social account number, and matching the acquired friend information with the contact information, then returning the friend information which is successfully matched to the intelligent terminal, by the server;

receiving and storing the friend information which is successfully matched, and recommending the friend information which is successfully matched to the user of the intelligent terminal, by the intelligent terminal; and

wherein the friend information which is successfully matched including information that has not been set in the contact information of the intelligent terminal.

Compared with the prior art, the method, system, intelligent terminal and storage medium for information recommendation provided in embodiments of the present disclosure at least have a beneficial effect that the server matches friend information of the social account number of the user with the contact information of the user uploaded by the intelligent terminal and returns the friend information which is successfully matched to the intelligent terminal for the recommendation to the user. The friend information which is successfully matched includes information that has not been set in the contact information of the intelligent terminal, therefore, the user may be assisted to complete the contact information in the address list of the intelligent terminal, so as to resolve the problem that in the address list of existing intelligent terminals the contact information is incomplete

### DESCRIPTION OF DRAWINGS

In order to clearly explain the technical solutions of the embodiments of the invention, figures used in the descriptions of the embodiments are briefly introduced as follows. Obviously, figures in the following descriptions only show some embodiments of the invention, and modifications and substitutions can also be made to these figures by those skilled in the art without any creative work.

FIG. 1 is a frame diagram of an information recommendation system provided in a first embodiment of the present disclosure;

FIG. 2 is an interactive flow chart of a method for information recommendation provided in a second embodiment of the present disclosure;

FIG. 3a and FIG. 3b of FIG. 3 are exemplary drawings of setting or contact images provided in a second embodiment of the present disclosure; and

FIG. 4 is a component structural diagram of an intelligent terminal provided in a third embodiment of the present disclosure.

### DETAILED DESCRIPTION OF PREFERRED EMBODIMENTS

The technical solutions in the embodiments of the present disclosure are clearly and completely described below in combination with the drawings. Obviously, the embodiments described are some but not all embodiments of the invention, in order to set forth the principle of the invention instead of limiting the invention to these specific embodiments. Based on embodiments of the invention, all other embodiments obtained by those skilled in the art without any creative work fall within the scope of the invention.

### A First Embodiment

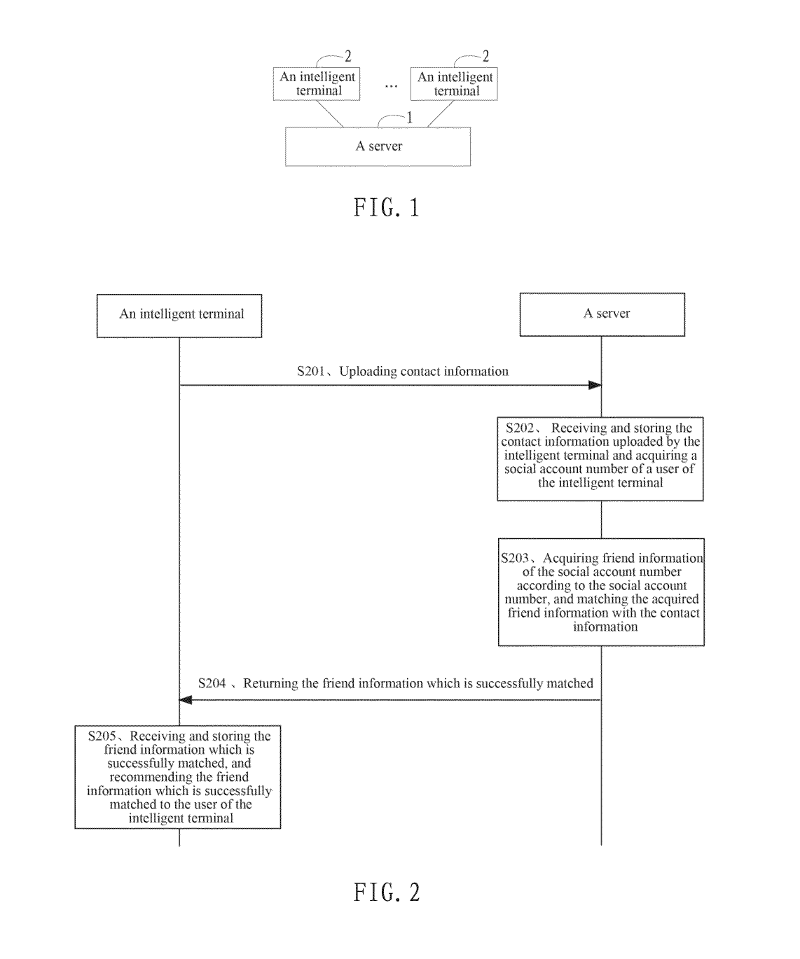

FIG. 1 shows a frame diagram of an information recommendation system provided in the first embodiment of the present disclosure. A method for information recommendation provided in embodiments of the present disclosure is applicable to the system information recommendation. For the convenient of description, only a portion of the method related to this embodiment is shown.

As shown in FIG. 1, the information recommendation system includes a server 1 and at least one intelligent terminal 2 communicated with the server 1 through a network connection.

The server 1 may be a single server or a server composed of a plurality of function servers.

The intelligent terminal 2 may be any terminal devices with network connection functions, including but not be limited to a cellular phone, a computer etc.

In this embodiment, in order to help a user complete contact information in the address list of the intelligent terminal to solve the problem that in the address list of existing intelligent terminals the contact information is incomplete, the intelligent terminal 2 may upload the contact information to the server 1, once the intelligent terminal 2 receiving a contact information recommendation instruction sent by the user or trigger information for contact information recommendation generated according to a predetermined time interval.

It should be noticed that the contact information of a user may be updated continuously, therefore, the user may preset a time interval (for example once a week) for uploading the contact information, so that when the time interval for uploading is reached, the intelligent terminal uploads the contact information automatically. The contact information uploaded may be all the stored contact information or newly updated contact information.

The server 1 receives and stores the contact information uploaded by the intelligent terminal 2, and acquires a social account number of the user of the intelligent terminal 2, then acquires friend information of the social account number according to the social account number, and matches the acquired friend information with the contact information, then returns the friend information which is successfully matched to the intelligent terminal 2.

The intelligent terminal 2 receives and stores the friend information which is successfully matched, and recommends the friend information which is successfully matched to the user of the intelligent terminal. The friend information which is successfully matched includes information that has not been set in the contact information of the intelligent terminal, such as image information and birthday information that have not been set.

Preferably, in order to ensure the accuracy of the imported information, this embodiment does not recommend automatic import but requires the user to confirm before performing corresponding import, therefore, after the intelligent terminal 2 recommends the friend information which is successfully matched to the user of the intelligent terminal, the intelligent terminal 2 is required to import the friend information which is successfully matched to complete the contact information once receiving an instruction indicating the user accepts recommended information. The recommended information is the friend information which is successfully matched.

Furthermore, the friend information which is successfully matched includes contact image information, however, a contact may have a plurality of different pieces image information (for example a QQ image, a Microblog image etc.), therefore:

the intelligent terminal is further configured to set a plurality of different images as images for a contact and display the plurality of different images at a predetermined time interval alternately, or set the updated image out of the plurality of different images as the image for the contact, if the contact has the plurality of different images, when imports the friend information which is successfully matched to complete the contact information.

Furthermore, the friend information which is successfully matched comprises the contact birthday information.

The intelligent terminal 2 is further configured to set contact birthday reminder information, which comprises at least one of an approach of reminding and a time of reminding, according to the imported contact birthday information.

In this embodiment, in order to increase the probability of the recommended information being accepted, a state in which the intelligent terminal recommends the friend information which is successfully matched to the user of the intelligent terminal may be preset. The preset state includes but not be limited to a state in which the intelligent terminal is in an idle state or in a contact information setting state.

### A Second Embodiment

FIG. 2 shows an interactive flow chart of a method for information recommendation provided in the second embodiment of the present disclosure. The procedure of the method is described below in detail and includes step S201, step S202, step S203, step S204 and step S206.

In the step S201, an intelligent terminal uploads contact information to a server;

In this embodiment, the intelligent terminal may upload the contact information in the intelligent terminal to the server once receiving a contact information recommendation instruction sent by the user or trigger information for contact information recommendation generated according to a predetermined time interval.

The contact information includes the contact's unique identification information such as the contact's name, cellular phone.

In the step S202, the server receives and stores the contact information uploaded by the intelligent terminal and acquires a social account number of a user of the intelligent terminal.

In this embodiment, when the server receives the contact information uploaded by the intelligent terminal, the server acquires the social account number (the social account number shown is an account number preset or applied by the user of the intelligent terminal) of the user of the intelligent terminal, such as an intelligent terminal binding with the intelligent terminal or an account number frequently logged in (logging times exceeds a preset value) through the intelligent terminal, according to the unique identification information of the intelligent terminal such as an IP (Internet Protocol) address, a physical address, an SIM (Subscriber Identity Module) card.

In the step S203, the server acquires friend information of the social account number according to the social account number, and matches the acquired friend information with the contact information.

In the step S204, the server returns the friend information which is successfully matched to the intelligent terminal.

In this embodiment, the friend information which is successfully matched includes information that has not been set in the contact information of the intelligent terminal, such as image information and birthday information that have not been set.

It should be noticed that the above said phase “successfully matched” means that at least one piece of identical information exist between the friend information and the contact information.

In the case of a QQ number, the server acquires friend information of the QQ number of the user of the intelligent terminal (for example, Zhangsan; QQ number: 123456; Birthday: November, 10; Email:123456@qq.com; Image of Zhangsan). If the server discovers after the match that in the contact information there is a contact whose Email is also 123456@qq.com, then the server determines that “Zhangsan” is successfully matched with the contact and sends information of “Zhangsan” to the intelligent terminal.

In the step S205, the intelligent terminal receives and stores the friend information Which is successfully matched, and recommends the friend information which is successfully matched to the user of the intelligent terminal.

In particular, the intelligent terminal may recommend the friend information Which is successfully matched to the user of the intelligent terminal while the intelligent terminal is in an idle state or in a contact information setting state.

Preferably, in order to ensure the accuracy of the imported information, this embodiment does not recommend automatic import but requires the user to confirm before performing corresponding import, therefore, the intelligent terminal in this embodiment is required to import the friend information which is successfully matched to complete the contact information once receiving an instruction indicating the user accepts recommended information. The recommended information is the friend information which is successfully matched.

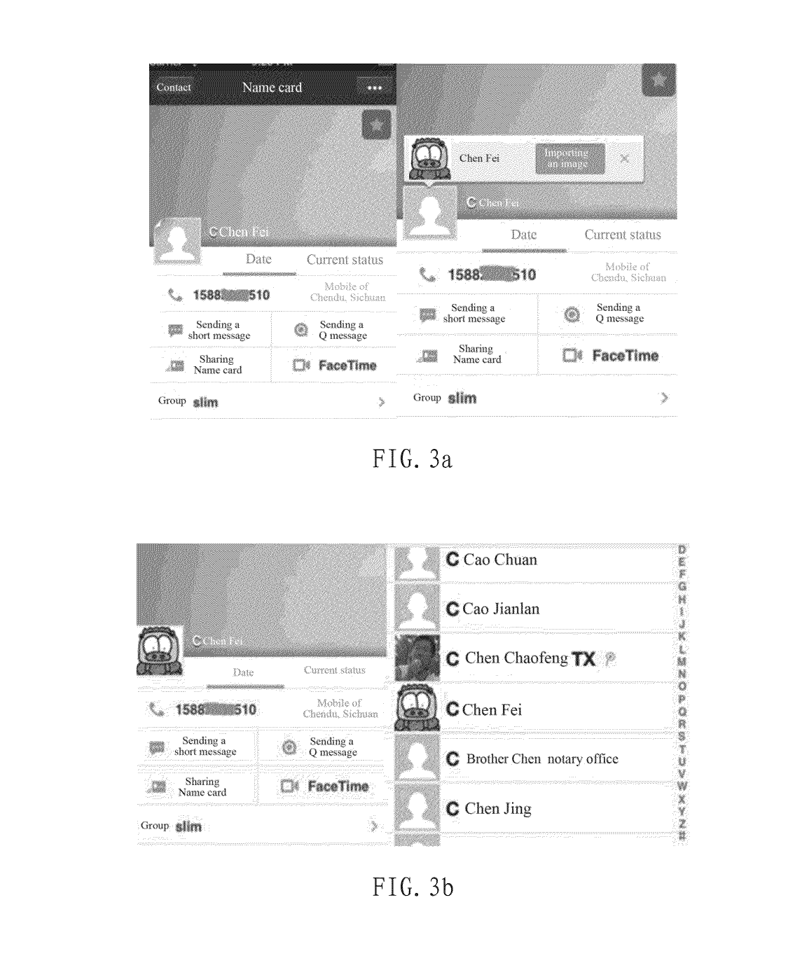

As shown in FIG. 3a, when enters a contact information setting interface, the intelligent terminal recommends matched information related to that contact. For example the intelligent terminal recommends matched image to the contact once the contact clicking a default image (the default image for a contact without an image is a curly state), then imports and displays the recommended image information after receiving a user confirmation instruction (as shown in FIG. 3b).

In this embodiment, when sets the image, the image of one contact can be set each time, or alternatively, a list of contacts whose images are to be set and a list of recommended images can be displayed on a screen in split screens, so as to set images of a plurality of contacts by a association operation.

In a specific application, the screen can be divided into two display areas, with one display area displaying the list of contacts whose images are to be set and the other display area displaying the list of recommended images. When the intelligent terminal detects an operation for drawing a line between a. contact and a. corresponding image, for dragging the contact and corresponding image or for continuously clicking on the contact and corresponding image and other operations, it's assumed that an association operation is occurred, so that the corresponding image is used as the image of the contact.

Furthermore, if a contact has a plurality of different images (such as an image for the QQ number and an image for the Microblog account number), the plurality of different images may be set as images for the contact, and the plurality of different images are displayed by a predetermined time interval alternately, such as each image is displayed every three days periodically in turn. Or alternatively, the updated image (i.e. an image of which the update time is most close to the system time) out of the plurality of different images is set as the image for the contact.

Furthermore, when the friend information which is successfully matched includes contact birthday information, this embodiment further includes the following.

The intelligent terminal set contact birthday reminder information, which includes at least one of an approach (such as ringing) of reminding and a time of reminding, according to the imported contact birthday information.

Furthermore, the reminder information may include a time interval of reminding, so that a plurality of reminder can be done before the time of reminding is reached.

For example, if the time of reminding is Sunday, then it can be set to remind once every other day in one week before the time of reminding, that is, one reminder is done on Monday, one reminder is done on Thursday, one reminder is done on Friday, before Sunday is arrived.

The information recommendation method provided in this embodiment of the present disclosure acquires friend information according to the social account number of the user and matches the acquired friend information with contact information in the address list of the intelligent terminal, so that the friend information Which is successfully matched is sent to the user to determine whether the recommended information is required to be imported into the address by the user. Since the friend information which is successfully matched includes information that has not been set in the contact information of the intelligent terminal, such as, the contact's image, birthday and other information, users are effectively helped to complete information of contacts in address list of intelligent terminals to solve the problem that in the address list of existing intelligent terminals the contact information is incomplete. Moreover. when imports the image of the contact, the image of one contact can be imported each time, or alternatively, images of a plurality contacts can be imported concurrently, In addition, if a contact has a plurality of different images (such as an image for the QQ number and an image for the Microblog account number), the plurality of different images may be set as images for the contact, and the plurality of different images are displayed by a predetermined time interval alternately, or alternatively, the updated image (i.e. an image of Which the update time is most close to the system time) out of the plurality of different images is set as the image for the contact. Moreover, once importing the contact birthday information, contact birthday reminder information can be set according to the imported contact birthday information, so that the user can be reminded when birthdays of contacts are approaching.

### A Third Embodiment

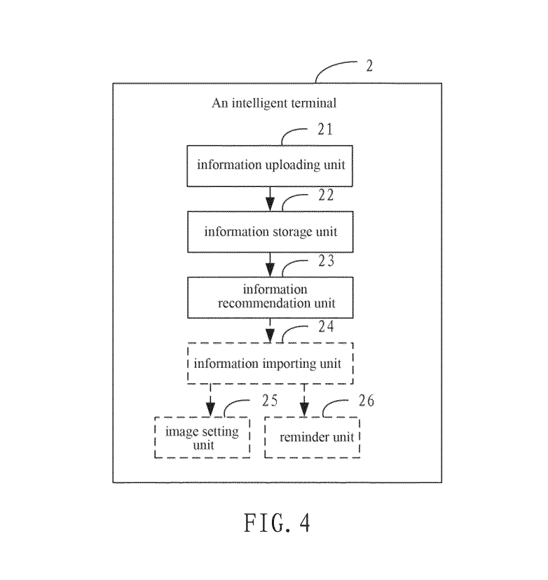

FIG. 4 shows a component structural diagram of an intelligent terminal provided in the third embodiment of the present disclosure. For the convenient of description, only a portion of the intelligent terminal related to this embodiment is shown.

The intelligent terminal 2 may be applied in the information recommendation system shown in FIG. 1.

The intelligent terminal 2 includes an information uploading unit 21, an information storage unit 22 and an information recommendation unit 23. The function of each unit is described below.

The information uploading unit 21 is configured to upload contact information to a server to enable the server to store the contact information and acquire a social account number of a user of the intelligent terminal once receiving the contact information, then acquire friend information of the social account number according to the social account number, and match the acquired friend information with the contact information, then return the friend information Which is successfully matched to the intelligent terminal.

The information storage unit 22 is configured to receive and store the friend information which is successfully matched returned b the server.

The information recommendation unit 23 is configured to recommend the friend information which is successfully matched to the user of the intelligent terminal. In particular, the recommending the friend information which is successfully matched can be recommended to the user of the intelligent terminal while the intelligent terminal is in an idle state or in a contact information setting state.

The friend information which is successfully matched comprises information that has not been set in the contact information of the intelligent terminal.

Furthermore, the intelligent terminal 2 further comprises an information importing unit 24.

The information importing unit 24 is configured to import the friend information Which is successfully matched to complete the contact information once receiving an instruction indicating the user accepts the recommended information which is the successfully matched friend information.

Furthermore, the friend information Which is successfully matched comprises contact image information.

The intelligent terminal 2 further comprises an image setting unit 25.

The image setting unit 25 is configured to set a plurality of different images as images for a contact and display the plurality of different images at a predetermined time interval alternately, or set the updated image out of the plurality of different images as the image for the contact, if the contact has the plurality of different images, when imports the friend information which is successfully matched to complete the contact information.

Furthermore, the friend information which is successfully matched comprises contact birthday information.

The intelligent terminal further comprises: a reminder unit 26.

The reminder unit 26 is configured to, set contact birthday reminder information, which comprises at least one of an approach of reminding and a time of reminding, according to the imported contact birthday information.

The intelligent terminal 2 provided in this embodiment may use the above said corresponding information recommendation method, the details of which are described in the above second embodiment therefore are not described necessarily here.

It can be understood by those skilled in this art that each unit included in the above third embodiment is divided by functional logics but not limited to the above said functional divisions as long as corresponding functions can be achieved; in addition, the name of each functional unit is only used for the purpose of convenient of discrimination but not for limiting the protecting scope of the invention.

In a summary, the intelligent terminal provided in this embodiment of the present disclosure acquires friend information according to the social account number of the user and matches the acquired friend information with contact information in the address list of the intelligent terminal, so that the friend information Which is successfully matched is sent to the user to determine whether the recommended information is required to be imported into the address by the user. Since the friend information which is successfully matched includes information that has not been set in the contact information of the intelligent terminal, such as, the contact's image, birthday and other information, users are effectively helped to complete information of contacts in address list of intelligent terminals to solve the problem that in the address list of existing intelligent terminals the contact information is incomplete. Moreover, when imports the image of the contact, the image of one contact can be imported each time, or alternatively, images of a plurality contacts can be imported concurrently. In addition, if a contact has a plurality of different images (such as an image for the QQ number and an image for the Microblog account number), the plurality of different images may be set as images for the contact, and the plurality of different images are displayed by a predetermined time interval alternately, or alternatively, the updated image (i.e. an image of which the update time is most close to the system time) out of the plurality of different images is set as the image for the contact. Moreover, once importing the contact birthday information, contact birthday reminder information can be set according to the imported contact birthday information, so that the user can be reminded when birthdays of contacts are approaching.

An embodiment of the invention provides a storage medium containing computer executable instructions for executing a method for information recommendation when executed by a computer processor, wherein, the method includes:

uploading contact information to a server, by an intelligent terminal;

storing the contact information uploaded by the intelligent terminal and acquiring a social account number of a. user of the intelligent terminal, by the server;

acquiring friend information of the social account number according to the social account number, and matching the acquired friend information with the contact information, then returning the friend information which is successfully matched to the intelligent terminal, by the server;

receiving and storing the friend information which is successfully matched, and recommending the friend information which is successfully matched to the user of the intelligent terminal, by the intelligent terminal; and

wherein the friend information which is successfully matched including information that has not been set in the contact information of the intelligent terminal.

It would be appreciated by those skilled in the art that all or some of the steps in the above embodiments can by performed by hardware, or by a software program instructing the related hardware. The program may be stored in a computer readable storage medium, including a soft disc of a computer, a ROM (Read Only Memory), a RAM (Radom Access Memory), a FLASH, a magnetic disc or a Compact Disk, etc.

The present disclosure is further described in detail in combination with specific preferred embodiments herein above, however, it can not be construed that specific preferred embodiments of the present disclosure is only limited to these descriptions. For those with ordinal skills in this art, all equivalent substitutions and apparent variants or equal functions and usages made without departing from the ideal of the present disclosure are considered as falling within the patent protecting scope of the invention, which is determined by the submitted claims.

1. A method for information recommendation, characterized by comprising the step of:
uploading contact information to a server, by an intelligent terminal;
storing the contact information uploaded by the intelligent terminal and acquiring a social account number of a user of the intelligent terminal, by the server;
acquiring friend information of the social account number according to the social account number, and matching the acquired friend information with the contact information, then returning the friend information which is successfully matched to the intelligent terminal, by the server;
receiving and storing the friend information which is successfully matched, and recommending the friend information which is successfully matched to the user of the intelligent terminal, by the intelligent terminal;
wherein the friend information which is successfully matched comprises information that has not been set in the contact information of the intelligent terminal.

2. The method according to claim 1, wherein, once the intelligent terminal recommending the friend information which is successfully matched to the user of the intelligent terminal, the method further comprises:
importing the friend information which is successfully matched to complete the contact information, by the intelligent terminal, once receiving an instruction indicating the user accepts recommended information, which is the successfully matched friend information.

3. The method according to claim 2, wherein, the friend information which is successfully matched comprises contact image information;
when the intelligent terminal imports the friend information which is successfully matched to complete the contact information, the method further comprises:
setting a plurality of different images as images for a contact and displaying the plurality of different images at a predetermined time interval alternately, or setting the updated image out of the plurality of different images as the image for the contact, if the contact has the plurality of different images.

4. The method according to claim 2, wherein, the friend information which is successfully matched comprises contact birthday information;
once the intelligent terminal importing the friend information which is successfully matched to complete the contact information, the method further comprises:
setting, by the intelligent terminal, contact birthday reminder information, which comprises at least one of an approach of reminding and a time of reminding, according to the imported contact birthday information.

5. The method according to claim 1, wherein, the step of receiving and storing the friend information which is successfully matched, and recommending the friend information which is successfully matched to the user of the intelligent terminal by the intelligent terminal comprises:
receiving and storing the friend information which is successfully matched, then recommending the friend information which is successfully matched to the user of the intelligent terminal, by the intelligent terminal, while the intelligent terminal is in an idle state or in a contact information setting state.

6. The method according to claim 2, wherein, the step of receiving and storing the friend information which is successfully matched, and recommending the friend information which is successfully matched to the user of the intelligent terminal by the intelligent terminal comprises:
receiving and storing the friend information which is successfully matched, then recommending the friend information which is successfully matched to the user of the intelligent terminal, by the intelligent terminal, while the intelligent terminal is in an idle state or in a contact information setting state.

7. The method according to claim 3, wherein, the step of receiving and storing the friend information which is successfully matched, and recommending the friend information which is successfully matched to the user of the intelligent terminal by the intelligent terminal comprises:
receiving and storing the friend information which is successfully matched, then recommending the friend information which is successfully matched to the user of the intelligent terminal, by the intelligent terminal, while the intelligent terminal is in an idle state or in a contact information setting state.

8. The method according to claim 4, wherein, the step of receiving and storing the friend information which is successfully matched, and recommending the friend information which is successfully matched to the user of the intelligent terminal by the intelligent terminal comprises:
receiving and storing the friend information which is successfully matched, then recommending the friend information which is successfully matched to the user of the intelligent terminal, by the intelligent terminal, while the intelligent terminal is in an idle state or in a contact information setting state.

9. A system for information recommendation, characterized by comprising:
a server and an intelligent terminal:
the intelligent terminal is configured to upload contact information to a server, receive and store the friend information which is successfully matched returned by the server, and recommend the friend information which is successfully matched to the user of the intelligent terminal;
the server is configured to store the contact information uploaded by the intelligent terminal and acquire a social account number of a user of the intelligent terminal, then acquire friend information of the social account number according to the social account number, and match the acquired friend information with the contact information, then return the friend information which is successfully matched to the intelligent terminal;
wherein the friend information which is successfully matched comprising information that has not been set in the contact information of the intelligent terminal.

10. The system according to claim 9, wherein, the intelligent terminal is further configured to import friend information which is successfully matched to complete the contact information once receiving an instruction that the user accepts recommended information which is the friend information which is successfully matched.

11. The system according to claim 10, wherein, the friend information which is successfully matched comprises contact image information;
the intelligent terminal is further configured to set a plurality of different images as images for a contact and display the plurality of different images at a predetermined time interval alternately, or set the updated image out of the plurality of different images as the image for the contact, if the contact has the plurality of different images, when imports the friend information which is successfully matched to complete the contact information.

12. The system according to claim 10, wherein, the friend information which is successfully matched comprises contact birthday information;
the intelligent terminal is further configured to set contact birthday reminder information, which comprises at least one of an approach of reminding and a time of reminding, according to the imported contact birthday information.

13. The system according to claim 9, wherein, the intelligent terminal is configured to recommend the friend information which is successfully matched to the user of the intelligent terminal while the intelligent terminal is in an idle state or in a contact information setting state.

14. The system according to claim 10, wherein, the intelligent terminal is configured to recommend the friend information which is successfully matched to the user of the intelligent terminal while the intelligent terminal is in an idle state or in a contact information setting state.

15. The system according to claim 11, wherein, the intelligent terminal is configured to recommend the friend information which is successfully matched to the user of the intelligent terminal while the intelligent terminal is in an idle state or in a contact information setting state.

16. An intelligent terminal, characterized by comprising:
an information uploading unit configured to upload contact information to a server to enable the server to store the contact information and acquire a social account number of a user of the intelligent terminal once receiving the contact information, then acquire friend information of the social account number according to the social account number, and match the acquired friend information with the contact information, then return the friend information which is successfully matched to the intelligent terminal;
an information storage unit configured to receive and store the friend information which is successfully matched returned by the server;
an information recommendation unit configured to recommend the friend information which is successfully matched to the user of the intelligent terminal;
wherein the friend information which is successfully matched comprising information that has not been set in the contact information of the intelligent terminal.

17. The intelligent terminal according to claim 16, wherein, the intelligent terminal further comprises:
an information importing unit configured to import the friend information which is successfully matched to complete the contact information once receiving an instruction that the user accepts the recommended information which is the successfully matched friend information.

18. The intelligent terminal according to claim 17 wherein, the friend information which is successfully matched comprises contact image information;
the intelligent terminal further comprises:
an image setting unit configured to set a plurality of different images as images for a contact and display the plurality of different images at a predetermined time interval alternately, or set the updated image out of the plurality of different images as the image for the contact, if the contact has the plurality of different images, when imports the friend information which is successfully matched to complete the contact information.

19. The intelligent terminal according to claim 17, Wherein, the friend information which is successfully matched comprises contact birthday information;
the intelligent terminal further comprises:
a reminder unit configured to set contact birthday reminder information, which comprises at least one of an approach of reminding and a. time of reminding, according to the imported contact birthday information.

20. The intelligent terminal according to claim 16, wherein, the intelligent terminal is configured to recommend the friend information which is successfully matched to the user of the intelligent terminal while the intelligent terminal is in an idle state or in a contact information setting state.
